(19) United States
(12) Patent Application Publication
(10) Pub. No.: US 2026/0287981 A1
(43) Pub. Date: Sep. 24, 2026

(54) Assistant Mobile Device and Card Holder

(71) Applicant: Ian Andrew Oberholtzer, Brooklyn, NY (US)

(72) Inventor: Ian Andrew Oberholtzer, Brooklyn, NY (US)

(21) Appl. No.: 19/572,534

(22) Filed: Mar. 19, 2026

Related U.S. Application Data
(60) Provisional application No. 63/774,479, filed on Mar. 19, 2025.

(51) Int. Cl. G03B 17/56; A63F 1/10; A63F 11/00

(52) U.S. Cl. CPC G03B 17/561; A63F 1/10; A63F 11/0051; A63F 2011/0058; G03B 2205/0084

(57) ABSTRACT

The assistant device for manual card scanning guides cards into a scanning position below a mobile device. The assistant mobile device and card holder seeks to provide users with a device that aligns a mobile device camera with the secured cards below to take pictures of the cards without any glare or shadows. The assistant mobile device and card holder has a stand arm which adjusts and positions the mobile device camera. A stand base receives and positions each card for scanning. The assistant mobile device and card holder is a lightweight, modular device that guides a card into a fixed position for scanning while ensuring the mobile device camera remains properly aligned with the card.

### FIELD OF THE INVENTION

The present invention relates generally to an assistant device for manual card scanning with a mobile device. More specifically, the present invention is a device that digitizes trading and gaming cards efficiently using a smartphone.

### BACKGROUND OF THE INVENTION

The growing popularity of trading card games (TCGs) has led to an increasing need for tools that enable users to efficiently catalog their collections digitally. Mobile applications that allow for scanning and logging trading cards are widely used, but accurately positioning a card under a mobile phone camera can be difficult, often resulting in misalignment, inconsistent image quality, and slower scanning times.

An objective of the present invention is to provide users with a device that provides a stable setup that allows users to position trading cards consistently within a camera's field of view for high-quality scanning. The present invention intends to provide users with a device that secures a mobile device 4 at a fixed angle to enable consistent, error-free image captures, which improves the speed and accuracy for collectors and sellers. In order to accomplish that, a preferred embodiment of the present invention comprises a stand arm 1 and a stand base 2. Further, the present invention improves the manual scanning process by providing a guided device for card placement and camera alignment. Thus, the present invention is a lightweight, modular device that guides a card into a fixed position for scanning while ensuring the mobile device 4 camera remains properly aligned.

### BRIEF DESCRIPTION OF THE DRAWINGS

FIG. 1 is a top front left perspective view of the present invention.

FIG. 2 is a bottom rear left perspective view of the present invention.

FIG. 3 is a top front right perspective view of the present invention supporting a mobile device along the stand arm and at least one card sliding along the funnel into the removable tray.

FIG. 4 is a bottom front right perspective view of the present invention supporting a mobile device along the stand arm and at least one card sliding along the funnel into the removable tray.

FIG. 5 is a top front left exploded perspective view of the present invention.

FIG. 6 is a top front right exploded perspective view of the present invention.

FIG. 7 is a bottom rear left exploded perspective view of the present invention.

FIG. 8 is a bottom rear right exploded perspective view of the present invention.

FIG. 9 is a front view of the present invention.

FIG. 10 is a rear view of the present invention.

FIG. 11 is a right-side view of the present invention wherein the two dashed lines indicate where the stand arm angle and stand base angle are being measured from with respect to the stand arm and stand base.

FIG. 12 is a left-side view of the present invention.

FIG. 13 is a top view of the present invention.

FIG. 14 is a bottom view of the present invention.

### DETAILED DESCRIPTION OF THE INVENTION

All illustrations of the drawings are for the purpose of describing selected versions of the present invention and are not intended to limit the scope of the present invention.

The present invention is an assistant device for manual card scanning to help with guiding cards into a scanning position. The present invention seeks to provide users with a device that aligns a mobile device 4 camera with the secured cards. In order to accomplish this the present invention comprises a stand arm 1 which adjusts and positions the mobile device 4 camera. Further, the stand base 2 receives and positions each card for scanning. Thus, the present invention is a lightweight, modular device that guides a card into a fixed position for scanning while ensuring the mobile device 4 camera remains properly aligned.

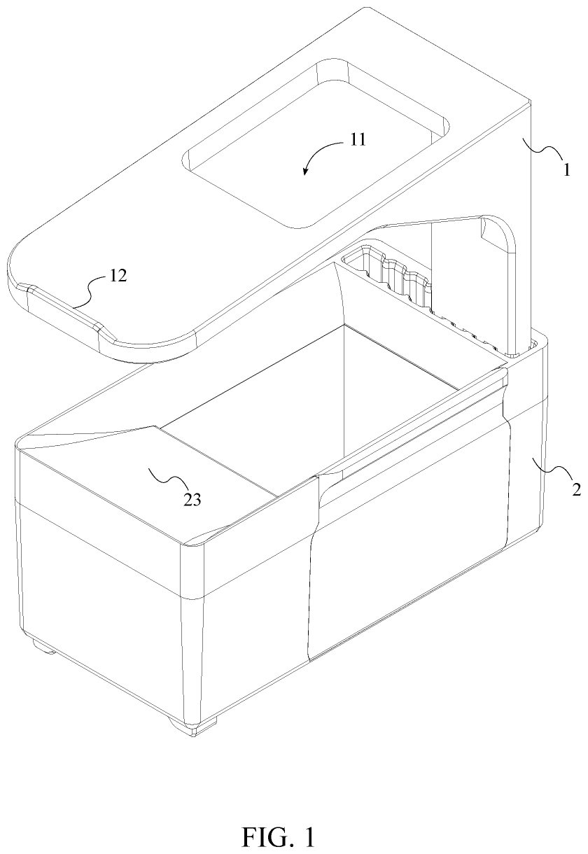

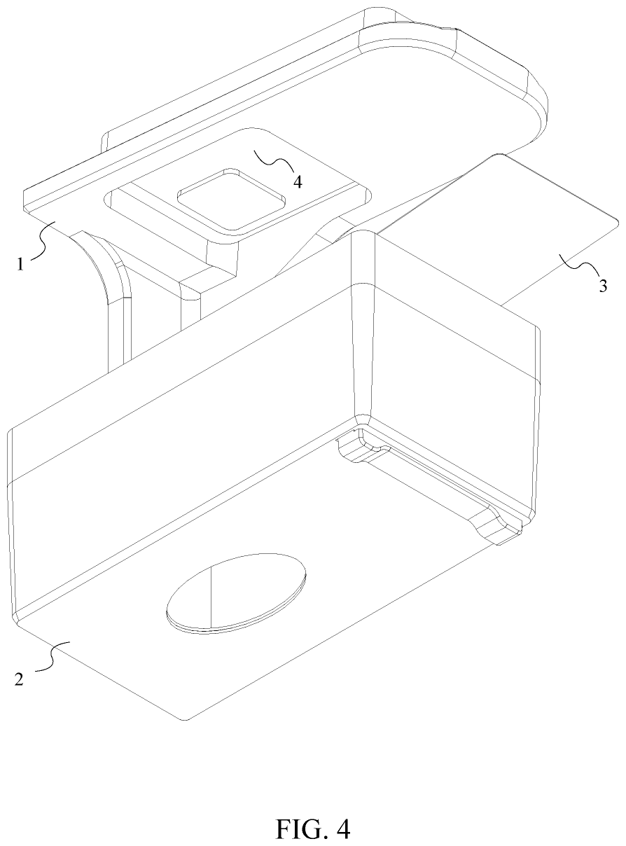

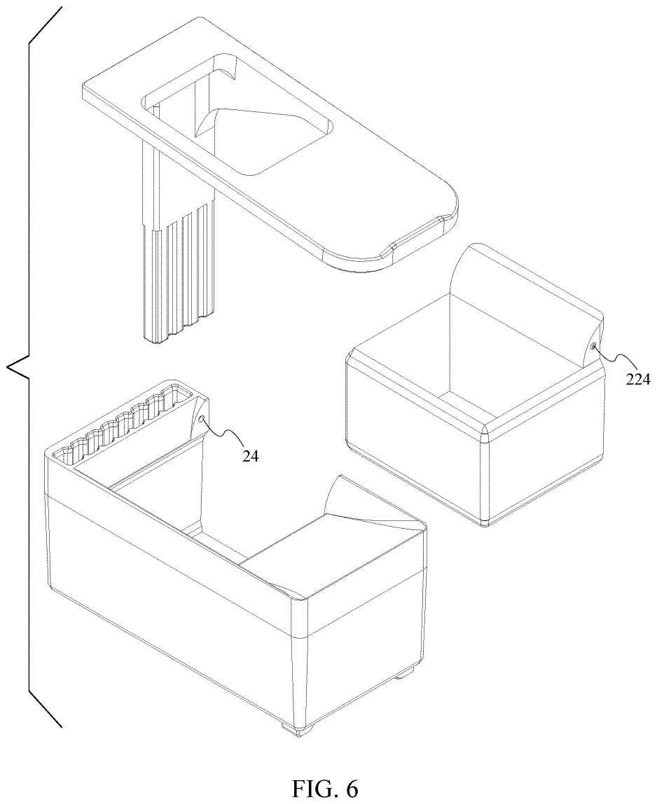

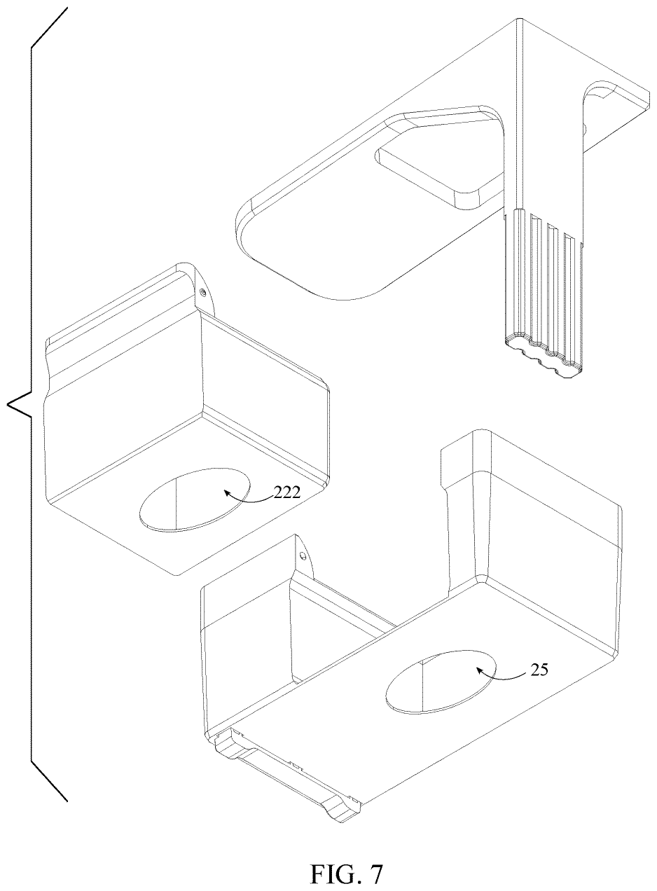

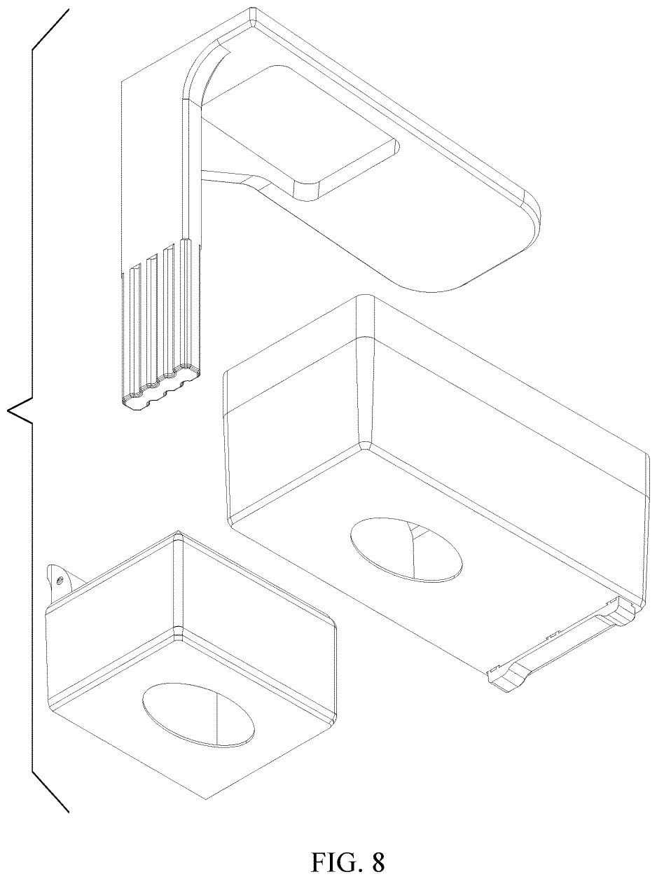

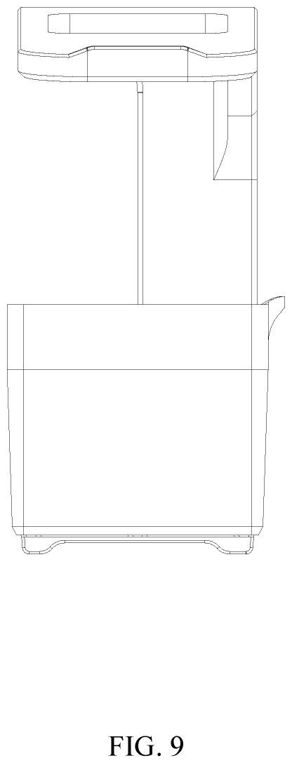

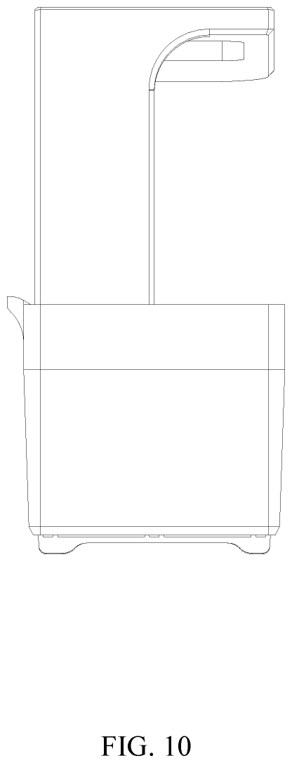

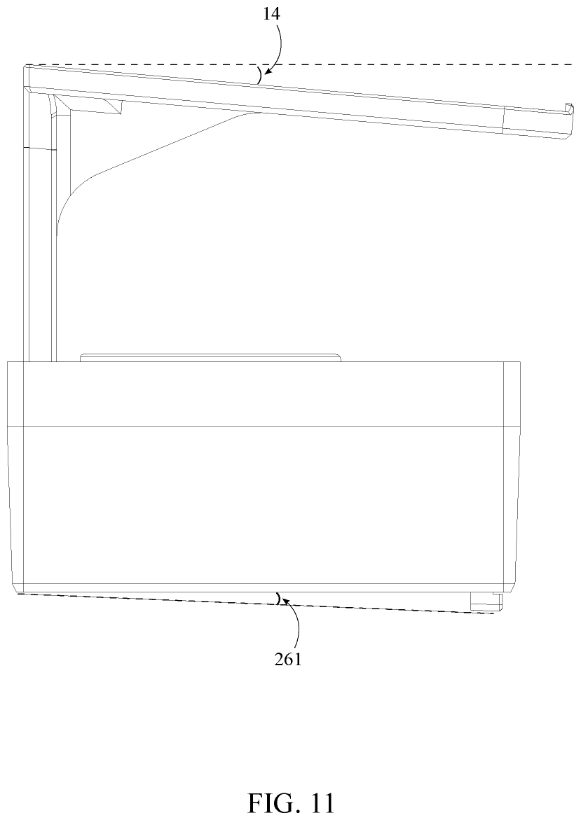

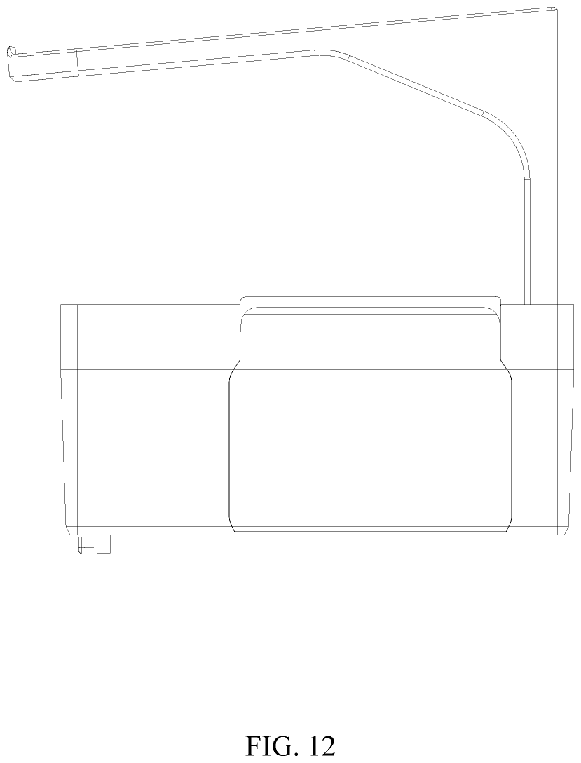

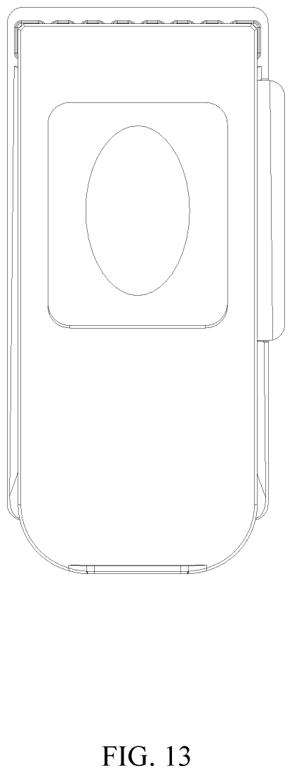

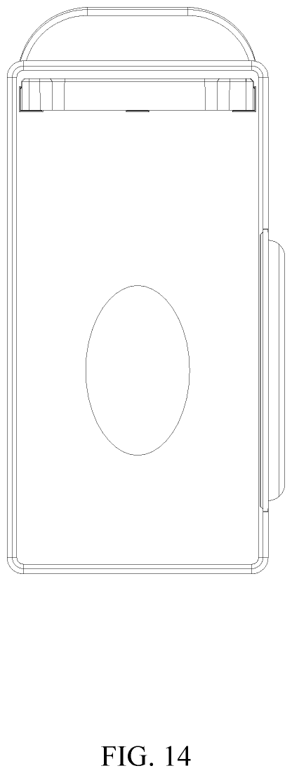

As shown in FIG. 1-14, the present invention is a device for scanning cards that automatically positions a mobile device 4 camera towards each card that automatically slides into the correct position. The present invention intends to provide users with a device that may adjust the positioning of the mobile device 4 camera to accommodate varying size and shaped mobile devices 4. To accomplish this the present invention comprises a stand arm 1 and a stand base 2. The stand arm 1 is received by the stand base 2 wherein the stand arm 1 extends upwards above the stand base 2. Thus, the present invention is a lightweight, modular device that guides a card into a fixed position for scanning while ensuring the mobile device 4 camera remains properly aligned.

The present invention provides a base wherein at least one card 3 may slide into place. The stand base 2 is configured to hold at least one card 3. The stand base 2 is designed with a hollow rectangular shape and is preferably designed with a transparent or semitransparent material, wherein light may pass through the base, illuminating the at least one card 3 held within.

The stand arm 1 is configured to hold a mobile device 4. The stand base 2 comprises a funnel 23 and a plurality of receiving grooves 21. As a result, the funnel 23 directs the at least one card 3 into the stand base 2 and the plurality of receiving grooves 21 enables the stand arm 1 to connect to the stand base 2. The stand base 2 and the stand arm 1 couples to one another to form a device that holds the mobile phone at a desired angle to the at least one card 3, wherein the mobile device 4 may take repeatable pictures of the at least one card 3 with minimal glare.

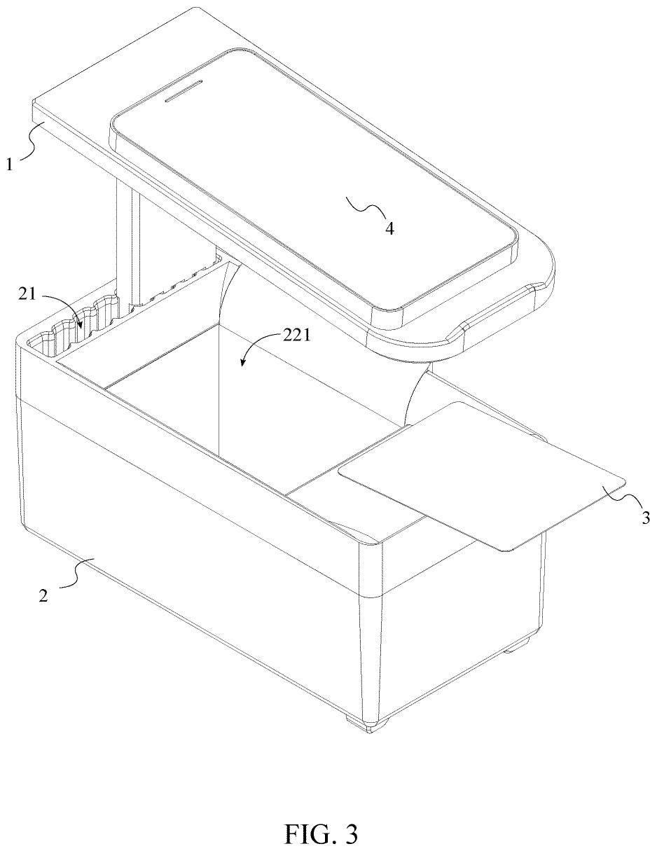

In its preferred embodiment the stand base 2 further comprises a plurality of receiving grooves 21, a removable tray 22, a plurality of dimple receivers 24, a plurality of feet 26, and a base hole 25. The plurality of receiving grooves 21 integrates along the rear top side of the stand base 2 as shown in FIG. 3. The plurality of receiving grooves 21 traverses downwards into the stand base 2. The plurality of receiving grooves 21 forms a series of conjoined holes. Accordingly, the stand arm 1 may fall into place within the stand base 2. The funnel 23 is positioned along the top front side of the stand base 2. Consequently, the funnel 23 directs the at least one card 3 to slide down into the stand base 2. The funnel 23 slants inwards towards the center of the stand base 2. Thus, the funnel 23 is designed to easily and properly guide the at least one card 3 into the stand base 2 and an attached removable tray 22.

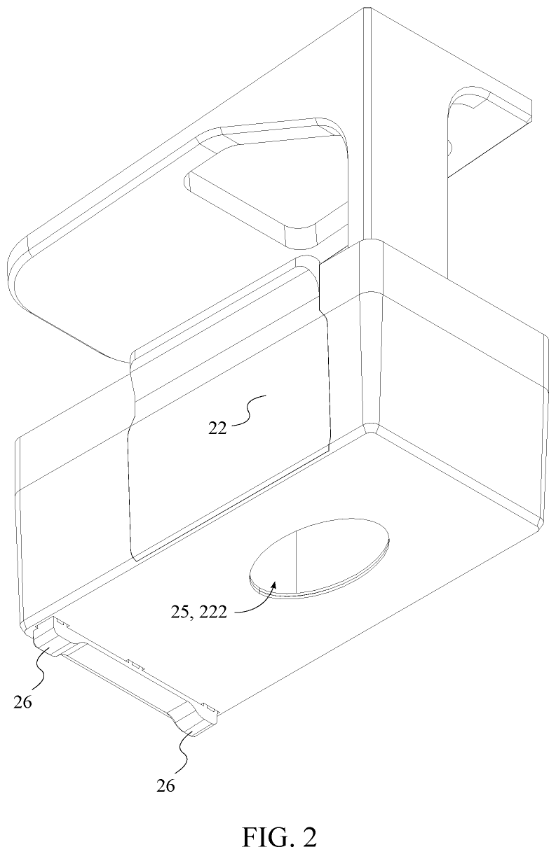

The removable tray 22 is positioned within the center right side of the stand base 2 as seen in FIG. 2. The removable tray 22 is a hollow rectangular shape with an opening. As a result, the removable tray 22 is designed to receive a standard card or standard trading card with a protective sleeve. The plurality of dimple receivers 24 is integrated along the surface of the stand base 2. Consequently, the plurality of dimple receivers 24 is in a position to engage with the removable tray 22. Each of the plurality of dimple receivers 24 is an indentation into the stand base 2, wherein the plurality of dimple receivers is a semi-spherical shape. The base hole 25 integrates along the bottom of the stand base 2. Accordingly, the base hole 25 traverses through the stand base 2 and provides an opening wherein air may escape as the card falls into the base stand. Furthermore, the base hole 25 may be utilized for card extraction. The plurality of feet 26 integrates along the bottom of the stand base 2, offset the base hole 25. Each of the plurality of feet 26 are positioned along the rear corners of the bottom of the stand base 2 and provide a gap below the stand base 2 and the surface placed upon. The plurality of feet 26 forms a stand base angle 261 when the stand base 2 is placed on a flat surface. Thus, the plurality of feet 26 determines the stand base angle 261 when rested on a surface.

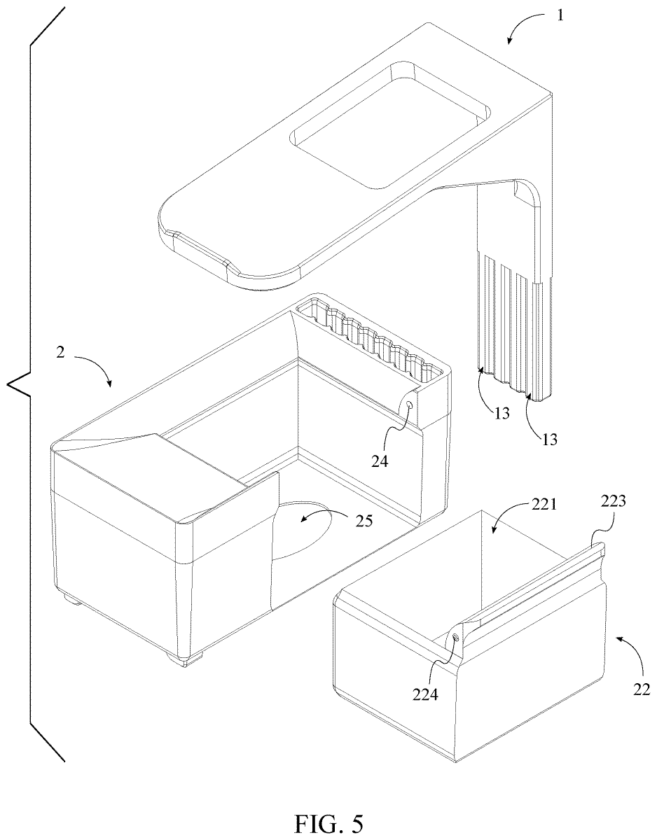

The removable tray 22 further comprises a tray opening 221, a tray hole 222, an edge 223, and a plurality of dimples 224 as seen in FIG. 5. The tray opening 221 is positioned along the top side of the removable tray 22 and is configured to enable the removable tray 22 to receive at least one card 3. The tray hole 222 is integrated along the bottom of the removable tray 22. So, the tray hole 222 is positioned opposite the tray opening 221. The tray hole 222 aligns with the base hole 25 when the removable tray 22 is secured within the stand base 2. This allows air to pass through the base hole 25 and tray hole 222 as the at least one card 3 is placed into the removable tray 22. The edge 223 is positioned along the left side of the removable tray 22. The edge 223 aligns with the surface of the left side of the stand base 2 when the removable tray 22 is secured within the stand base 2. As a result, the left side of the stand base 2 has a flush surface when the removable tray 22 is placed into the stand base 2. The plurality of dimples 224 is integrated on the front and rear sides of the edge 223. Consequently, this enables the front and rear sides of the removable tray 22 to engage with the stand base 2. Each of the plurality of dimples 224 is a semi-spherical shape that aligns with each of the plurality of dimple receivers 24. The plurality of dimples 224 engages with the plurality of dimple receivers 24. Accordingly, the plurality of dimples 224 enables the removable tray 22 to lock into the stand base 2. This design enables the user to lock the removable tray 22 in place along the stand base 2 and remove as needed with minimal force.

Furthermore, the stand base 2 and removable tray 22 is a semi-transparent material to enable light to pass through each component. Thus, light may pass through the stand base 2 or removable tray 22 in order to illuminate the at least one card 3 held within the removable tray 22. This configuration ensures that no unwanted shadows are cast onto the at least one card 3 while held within the removable tray 22. The removable tray 22 is configured to receive at least 200 cards. It should be further noted that the stand base 2 may be created in various shapes and sizes and the removable tray 22 may be coupled to the stand base 2 in various ways while still staying within the scope of the present invention.

The stand arm 1 extends upwards above the stand base 2 and is designed to secure a mobile device 4 camera directly above the removable tray 22 as seen in FIG. 3. The stand arm 1 is an L shaped bracket. In the preferred embodiment the stand arm 1 is a lightweight plastic material. In its preferred embodiment the stand arm 1 comprises a camera hole 11, a ridge 12, a plurality of interlocking grooves 13, and a stand arm angle 14. The camera hole 11 is a rectangular shaped hole. The camera hole 11 is positioned along the top side of the stand arm 1. The camera hole 11 traverses through the stand arm 1 surface wherein a camera is positioned within the camera hole 11. So, the camera hole 11 enables the mobile device 4 to take pictures of the at least one card 3 below.

Further, the ridge 12 integrates along the top side of the stand arm 1 as seen in FIG. 1. The ridge 12 is positioned offset the camera hole 11. Thus, the ridge 12 is positioned along the front end of the stand arm 1. The ridge 12 is configured to provide a stopping point for the mobile device 4 being held along the top side of the stand arm 1.

The plurality of interlocking grooves 13 is positioned along the bottom of the stand arm 1 shown in FIG. 5. The plurality of interlocking grooves 13 is a series of members with a size and shape, wherein the stand arm 1 may move horizontally left and right with respect to the stand base 2. The stand arm 1 engages into set positions along the stand base 2, dictated by the plurality of receiving grooves 21, wherein the stand arm 1 may move horizontally left and right with respect to the stand base 2. As a result, the stand arm 1 may accommodate various shaped and sized mobile devices 4 and cameras, ensuring the mobile device 4 camera lines up with the at least one card 3 below in the removable tray 22. The stand arm 1 forms a stand arm angle 14 to hold the mobile device 4 at the stand arm angle 14 to prevent glare when taking a photo of the at least one card 3 below in the removable tray 22. The ridge 12 further ensures that the mobile device 4 does not slide off of the stand arm 1 due to the stand arm angle 14.

In an alternative embodiment the plurality of interlocking grooves 13 further comprises a plurality of notches. The plurality of notches is integrated along the length of the plurality of interlocking grooves 13. The plurality of notches is designed to adjust the height of the stand arm 1 by locking into different levels of the plurality of receiving grooves 21. The present invention may further be presented in a multitude of angles to best accommodate various phone and cameras that are used to take pictures of the at least one card 3. Furthermore, the stand arm 1 may utilize various different angles to accommodate different phones and applications. With all the components working in tandem with each other it can be seen that the present invention is a lightweight, modular device that guides at least one card 3 into a fixed position for scanning while ensuring the mobile device 4 camera remains properly aligned.

Although the invention has been explained in relation to its preferred embodiment, it is to be understood that many other possible modifications and variations can be made without departing from the spirit and scope of the invention as hereinafter claimed.

What is claimed is:

1. An assistant mobile device and card holder comprising:
a stand base and a stand arm;
the stand base being configured to hold at least one card;
the stand arm being configured to hold a mobile device;
the stand base comprising a funnel and a plurality of receiving grooves; and
the stand base and the stand arm coupling to one another to form a device that holds the mobile phone at a desired angle to the at least one card, wherein the mobile device may take repeatable pictures of the at least one card with minimal glare.

2. The assistant mobile device and card holder as claimed in claim 1 comprising:
the stand base further comprising a removable tray, a plurality of dimple receivers, a base hole, and a plurality of feet;
the plurality of receiving grooves integrating along the stand base;
the plurality of receiving grooves traversing downwards into the stand base;
the plurality of receiving grooves forming a series of conjoined holes;
the funnel being positioned along the stand base; and
the funnel slanting inwards towards the center of the stand base.

3. The assistant mobile device and card holder as claimed in claim 2 comprising:
the removable tray being positioned within the stand base;
the removable tray being a hollow rectangular shape;
the plurality of dimple receivers being integrated along the surface of the stand base;
each of the plurality of dimple receivers being an indentation into the stand base;
the base hole integrating along the stand base;
the plurality of feet integrating along the stand base, offset the base hole; and
the plurality of feet forming a stand base angle when the stand base is placed on a flat surface.

4. The assistant mobile device and card holder as claimed in claim 3 comprising:
the removable tray further comprising a tray opening, a tray hole, an edge, and a plurality of dimples;
the tray opening is positioned along the removable tray and is configured to enable the removable tray to receive at least one card;
the tray hole being integrated along the removable tray;
the tray hole aligning with the base hole when the removable tray is secured within the stand base;
the edge being positioned along the removable tray;
the edge aligning with the surface of the stand base when the removable tray is secured within the stand base; and
the plurality of dimples being integrated on the edge.

5. The assistant mobile device and card holder as claimed in claim 3 comprising:
each of the plurality of dimples being a bump that aligns with each of the plurality of dimple receivers; and
the plurality of dimples engaging with the plurality of dimple receivers.

6. The assistant mobile device and card holder as claimed in claim 2 wherein the stand arm further comprising a camera hole, a ridge, a plurality of interlocking grooves, and a stand arm angle.

7. The assistant mobile device and card holder as claimed in claim 6 comprising:
the camera hole being positioned along the stand arm; and
the camera hole traversing through the stand arm surface wherein a camera is positioned within or above the camera hole.

8. The assistant mobile device and card holder as claimed in claim 7 comprising:
the ridge integrating along the stand arm;
the ridge being positioned offset the camera hole; and
the ridge being configured to provide a stopping point for the mobile device being held along the top side of the stand arm.

9. The assistant mobile device and card holder as claimed in claim 6 comprising:
the plurality of interlocking grooves being positioned along the stand arm;
the plurality of interlocking grooves being a series of members with a size and shape, wherein the plurality of interlocking grooves engages with the plurality of receiving grooves; and
the stand arm may engage into set positions along the stand base, dictated by the plurality of receiving grooves, wherein the stand arm may move horizontally left and right with respect to the stand base.

10. The assistant mobile device and card holder as claimed in claim 6 wherein the stand arm forms a stand arm angle to hold the mobile device at the stand arm angle to prevent glare when taking a photo of the at least one card below in the removable tray.

11. An assistant mobile device and card holder comprising:
a stand base and a stand arm;
the stand base being configured to hold at least one card;
the stand arm being configured to hold a mobile device;
the stand base comprising a funnel and a plurality of receiving grooves;
the stand base and the stand arm coupling to one another to form a device that holds the mobile phone at a desired angle to the at least one card, wherein the mobile device may take repeatable pictures of the at least one card with minimal glare;
the stand base further comprising a removable tray, a plurality of dimple receivers, a base hole, and a plurality of feet;
the plurality of receiving grooves integrating along the stand base;
the plurality of receiving grooves traversing downwards into the stand base;
the plurality of receiving grooves forming a series of conjoined holes;
the funnel being positioned along the stand base; and
the funnel slanting inwards towards the center of the stand base.

12. The assistant mobile device and card holder as claimed in claim 11 comprising:
the removable tray being positioned within the stand base;
the removable tray being a hollow rectangular shape;
the plurality of dimple receivers being integrated along the surface of the stand base;
each of the plurality of dimple receivers being an indentation into the stand base;
the base hole integrating along the stand base;
the plurality of feet integrating along the stand base, offset the base hole;
the plurality of feet forming a stand base angle when the stand base is placed on a flat surface;
the removable tray further comprising a tray opening, a tray hole, an edge, and a plurality of dimples;
the tray opening is positioned along the removable tray and is configured to enable the removable tray to receive at least one card;
the tray hole being integrated along the removable tray;
the tray hole aligning with the base hole when the removable tray is secured within the stand base;
the edge being positioned along the removable tray;
the edge aligning with the surface of the stand base when the removable tray is secured within the stand base; and
the plurality of dimples being integrated on the edge.

13. The assistant mobile device and card holder as claimed in claim 12 comprising:
each of the plurality of dimples being a bump that aligns with each of the plurality of dimple receivers; and
the plurality of dimples engaging with the plurality of dimple receivers.

14. The assistant mobile device and card holder as claimed in claim 11 wherein the stand arm further comprising a camera hole, a ridge, a plurality of interlocking grooves, and a stand arm angle.

15. The assistant mobile device and card holder as claimed in claim 14 comprising:
the camera hole being positioned along the stand arm;
the camera hole traversing through the stand arm surface wherein a camera is positioned within or above the camera hole;
the ridge integrating along the stand arm;
the ridge being positioned offset the camera hole; and
the ridge being configured to provide a stopping point for the mobile device being held along the top side of the stand arm.

16. The assistant mobile device and card holder as claimed in claim 14 comprising:
the plurality of interlocking grooves being positioned along the stand arm;
the plurality of interlocking grooves being a series of members with a size and shape, wherein the plurality of interlocking grooves engages with the plurality of receiving grooves; and
the stand arm may engage into set positions along the stand base, dictated by the plurality of receiving grooves, wherein the stand arm may move horizontally left and right with respect to the stand base.

17. The assistant mobile device and card holder as claimed in claim 14 wherein the stand arm forms a stand arm angle to hold the mobile device at the stand arm angle to prevent glare when taking a photo of the at least one card below in the removable tray.

18. An assistant mobile device and card holder comprising:
a stand base and a stand arm;
the stand base being configured to hold at least one card;
the stand arm being configured to hold a mobile device;
the stand base comprising a funnel and a plurality of receiving grooves;
the stand base and the stand arm coupling to one another to form a device that holds the mobile phone at a desired angle to the at least one card, wherein the mobile device may take repeatable pictures of the at least one card with minimal glare;
the stand base further comprising a removable tray, a plurality of dimple receivers, a base hole, and a plurality of feet;
the plurality of receiving grooves integrating along the stand base;
the plurality of receiving grooves traversing downwards into the stand base;
the plurality of receiving grooves forming a series of conjoined holes;
the funnel being positioned along the stand base;
the funnel slanting inwards towards the center of the stand base;
the removable tray being positioned within the stand base; and
the removable tray being a hollow rectangular shape.

19. The assistant mobile device and card holder as claimed in claim 18 comprising:
the plurality of dimple receivers being integrated along the surface of the stand base;
each of the plurality of dimple receivers being an indentation into the stand base;
the base hole integrating along the stand base;
the plurality of feet integrating along the stand base, offset the base hole;
the plurality of feet forming a stand base angle when the stand base is placed on a flat surface;
the removable tray further comprising a tray opening, a tray hole, an edge, and a plurality of dimples;
the tray opening is positioned along the removable tray and is configured to enable the removable tray to receive at least one card;
the tray hole being integrated along the removable tray;
the tray hole aligning with the base hole when the removable tray is secured within the stand base;
the edge being positioned along the removable tray;
the edge aligning with the surface of the stand base when the removable tray is secured within the stand base;
the plurality of dimples being integrated on the edge;
each of the plurality of dimples being a bump that aligns with each of the plurality of dimple receivers;
the plurality of dimples engaging with the plurality of dimple receivers; and
the stand arm further comprising a camera hole, a ridge, a plurality of interlocking grooves, and a stand arm angle.

20. The assistant mobile device and card holder as claimed in claim 19 comprising:
the camera hole being positioned along the stand arm;
the camera hole traversing through the stand arm surface wherein a camera is positioned within or above the camera hole;
the ridge integrating along the stand arm;
the ridge being positioned offset the camera hole;
the ridge being configured to provide a stopping point for the mobile device being held along the top side of the stand arm;
the plurality of interlocking grooves being positioned along the stand arm;
the plurality of interlocking grooves being a series of members with a size and shape, wherein the plurality of interlocking grooves engages with the plurality of receiving grooves;
the stand arm may engage into set positions along the stand base, dictated by the plurality of receiving grooves, wherein the stand arm may move horizontally left and right with respect to the stand base; and
the stand arm forms a stand arm angle to hold the mobile device at the stand arm angle to prevent glare when taking a photo of the at least one card below in the removable tray.
